(19) United States
(12) Patent Application Publication
(10) Pub. No.: US 2021/0337853 A1
(43) Pub. Date: Nov. 4, 2021

(54) METHOD OF MAKING A CONSUMABLE FOR LOW CARBOHYDRATE SNACKING

(71) Applicant: Joann Rodriguez, Naugatuck, CT (US)

(72) Inventor: Joann Rodriguez, Naugatuck, CT (US)

(21) Appl. No.: 15/929,468

(22) Filed: May 4, 2020

(51) Int. Cl. A23L 33/00; A23L 13/40; A23L 29/30; A23L 5/10; A23P 20/20; A23P 20/10

(52) U.S. Cl. CPC A23L 33/30; A23L 13/424; A23L 13/428; A23P 20/10; A23L 5/10; A23P 20/20; A23L 29/30

(57) ABSTRACT

A process for producing a consumable for low carbohydrate snacking is provided. The process includes one or more consumables embodies a method of infusing a protein by way of encasing the protein in lactose-free dairy products, eliminating the need for adding sugars and salts to cure the protein as well as enabling high-temperature applications, thereby lessening the time for drying the resultant consumable.

### BACKGROUND OF THE INVENTION

The present invention relates to methods for producing consumables and, more particularly, to a method of making a cheese bark infused with spicy hot meat jerky for low carbohydrate snacking.

Making traditional meat jerky requires a long dehydration time to cure and dry the meats. Also, traditional jerky requires adding salts and sugars, essential for said long process of curing and drying. Moreover, the flavoring of traditional jerky requires artificial flavorings and sodium (e.g., artificial smoke liquids). All in all, typically rendering the jerky hard and chewy, and high in sodium. It is well established that adding artificial flavors, salts and sugars are not favorable for healthy eating.

Furthermore, in the field of snacks, cheese crisp snacks lack a flavorful sensory experience. In other words, they do not satisfy hunger when eaten in moderation, and so the consumer tends to eat them in an excessive amount to gain satisfaction from hunger when snacking in between meals because they do not contain sustenance. Simply put, they are simply plain crunchy cheese wafers.

There is no creation in this field that incorporates cured jerky meat and cheeses baked and fused together with spicy hot pepper sauces and all-natural antimicrobial herbs and spices. Cheese bark is not even produced in the field of low carb snacking. Which is unfortunate as cheese bark can provide crispy, cheese-laden sheets with spicy hot real meat jerky infused with natural microbial resistant, antioxidants throughout.

As can be seen, there is a need for a method of making a consumable for healthy low-carbohydrate, low-salt, low-sugar snacking.

The present invention contains all-natural antibacterial herbs and spices to prohibit bacterial growth, and innovatively has a significantly shorter drying time, and so no added sugar or added salt is required. The cheese bark embodied in the present invention unleashes a palatable sensory experience from the spicy hot low-sodium sauces and hot peppers without adding artificial flavoring—providing a unique new way of low-carbohydrate (“low carb”) snacking. The cheese bark adds variety to enjoying meat jerky's and cheesy snacks as it is easy to chew and highly digestible as a result of the lactose-free cheese ensemble that is incorporated in the method of producing the consumable embodied in the present invention.

The present invention also eliminates the need for adding extra salts and sugars to dehydrate and cure the meat, as well as excludes artificial flavoring, yet provides a flavorful sensory experience and offers sustenance from its combined ingredients. The ingredients are exclusively natural, antibacterial, antimicrobial and antifungal specifically for curing the meat and keeping the cheese bark fit for consumption without long drying times and without sugars and salts and artificial flavorings. For instance, in certain embodiments, only the lowest sodium cayenne hot sauces are incorporated in the resulting consumable of the inventive method. Moreover, the ordered combination of various ad hoc tasks, through the specific processes described more in detail below, embodies unconventional and unique steps of making a consumable in sharp contrast to merely providing a well-known or obvious recipe of ingredients.

### SUMMARY OF THE INVENTION

In one aspect of the present invention, a method for producing a consumable for low-carbohydrate snacking, including the following: mixing a protein and one or more seasonings to form a first base composition; providing a sheet having thermal conductive properties; spreading the first base composition on said sheet sprinkling one or more lactose-free dairy products over the first base composition; and subjecting said sheet to a predetermine temperature for a predetermined length of time so as to infuse said one or more seasonings into said protein resulting in a low-carbohydrate snack, whereby adding sugars and salts to cure the protein is eliminated and lessening a drying time for the low-carbohydrate snack.

In another aspect of the present invention, the method for producing a consumable for low-carbohydrate snacking further provides that protein includes one protein selected from the group having of a portion of pre-cooked beef, a portion of pre-cooked chicken, and a portion of pre-cooked pork, wherein the one or more seasonings includes one or more herbs and spices selected from the group having of a chipotle pepper, a garlic powder, a cumin, a black pepper, a dehydrated sofrito, and a cayenne pepper, and wherein the one or more lactose-free dairy products includes one or more cheeses selected from the group consisting of a muenster cheese, a parmesan cheese, and a cedar cheese; and further including dousing an acidic fluid over the one or more lactose-free dairy products prior to subjecting the sheet to the predetermine temperature.

These and other features, aspects and advantages of the present invention will become better understood with reference to the following drawings, description and claims.

### BRIEF DESCRIPTION OF THE DRAWINGS

FIG. 1 is a flow chart of an exemplary embodiment of the basic jerky and cheese bark preparation of the present invention;

FIG. 2 is a flow chart of an exemplary embodiment for buffalo chicken bark jerky of the present invention;

FIG. 3 is a flow chart of an exemplary embodiment for chipotle beef cheese bark jerky of the present invention; and

FIG. 4 is a flow chart of an exemplary embodiment for chipotle pork cheese bark of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a process of producing a consumable for low carbohydrate snacking. The process includes one or more consumables embodies a method of infusing a protein by way of encasing the protein in lactose-free dairy products, eliminating the need for adding sugars and salts to cure the protein as well as enabling high-temperature applications, thereby lessening the time for drying the resultant consumable.

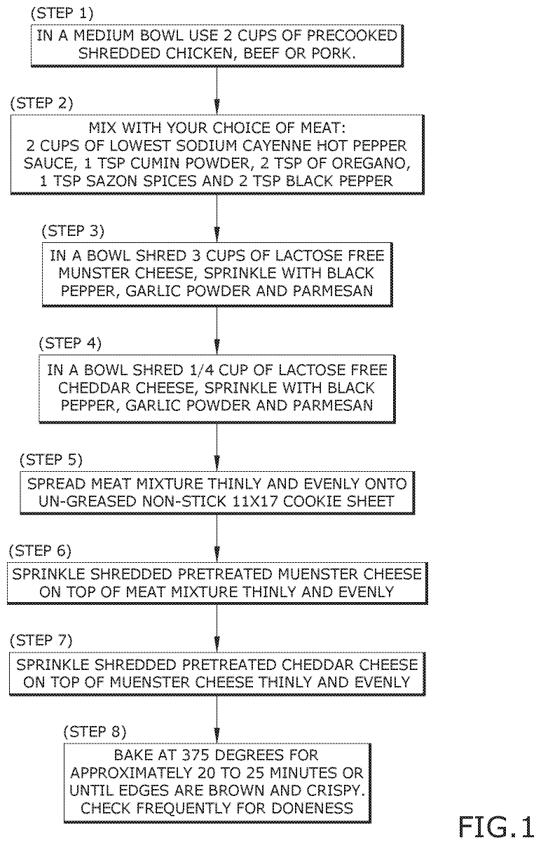

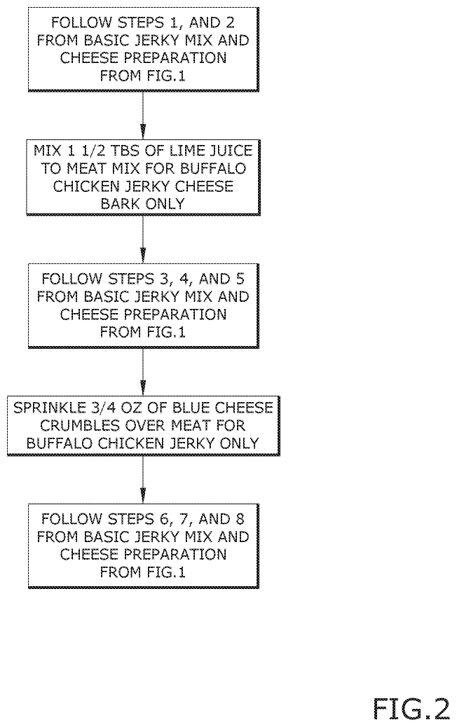

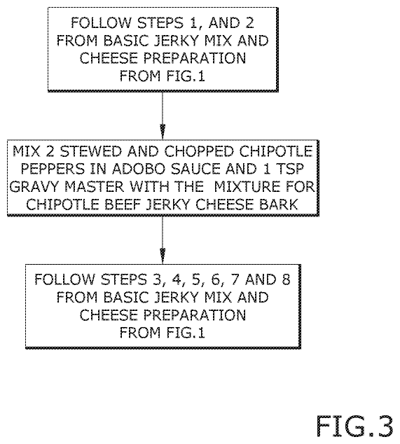

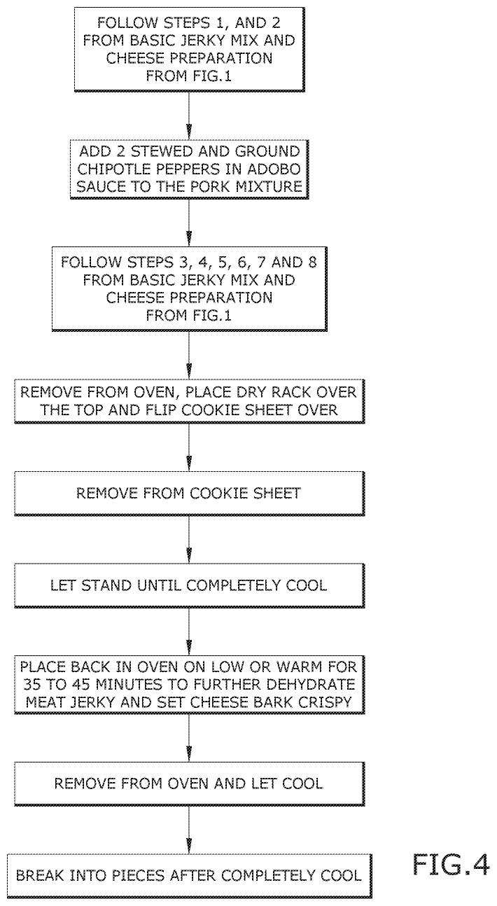

Referring to FIGS. 1 through 4, the present invention may include a process of producing a consumable for low carbohydrate snacking.

Said process may include a first method of providing a first base composition, the first method possibly having the following steps:

The first method may include a step of adding a predetermined amount of a first protein to a first container, in one embodiment two cups of cooked shredded beef brisket to a bowl.

The first method may include an additional step of adding a predetermined amount of first herbs and spices to the first container, in one embodiment two chipotle peppers in adobo sauce and/or one and a half to two cups of the lowest sodium hot cayenne pepper sauce.

The first method may include an additional step of adding a predetermined amount of second seasonings to the first container, in one embodiment one teaspoon (tsp) of each of the following: garlic powder, ground cumin, and low-sodium dehydrated sofrito seasoning, and two tsp ground black pepper.

The first method may include an additional step of mixing the first base composition in the first container until the first protein is saturated with the first and second seasonings, whereby the antioxidant rich antibacterial seasonings (herbs and spices) starts the jerky process.

Said process may include a first preparation method of preparing the first base composition, the first preparation method possibly having the following steps:

The first preparation method may include a step of providing a cooking apparatus, in one embodiment one 11×17 non-stick non-greased cookie sheet.

The first preparation method may include an additional step of thinly spreading a first spread of the first base composition on said cooking apparatus. Said first spread may have a thickness of about ⅛ of an inch; in some embodiments, the thickness is between 1/16th and ¼th of an inch.

Regarding the now thinly spread first base composition, the first method may include an additional step of adding a predetermined amount of a soy-based seasoning or beef bouillon on the first base composition, in one embodiment of the soy-based seasoning.

The first method may include an additional step of adding a predetermined amount of a first lactose-free dairy on the first base composition, in one embodiment three cups shredded lactose free Muenster cheese sprinkled with grated parmesan ground black pepper and garlic powder.

Note, the inventor has discovered that the property of grated parmesan when combined with the heavier shredded muenster, cheddar, and blue cheeses prevent the heavier cheeses from clumping when prepared/shredded and combined. Currently, practitioners use wood cellulose to prevent clumping, but the inventor, through extensive taste-testing, has determined wood cellulose and other non-cheese (i.e., grated parmesan) equivalents result in an inferior/unappetizing taste/after-taste compared to using grated parmesan cheese for the same purpose. Moreover, added wood cellulose and equivalents results in a food product that looks like (and arguably tastes like) a hockey puck, in contrast to the glass-like look of the present invention's resulting food product.

The first method may include an additional step of adding a predetermined amount of a second lactose-free dairy on the first base composition, in one embodiment ¼ cup lactose free zested cheddar cheese also sparsely sprinkled with black pepper garlic powder and black pepper. The inventor has discovered that the lactose-free zested cheddar should be added last (on top of the other lactose-free cheese, prior to cooking) as it is most sensitive to heat. This zested cheddar sinks into the other lactose-free cheeses.

The first protein always goes on the cooking apparatus first to be covered with the lactose-free dairy products in order the first protein infuses or becomes encased in the lactose-free dairy products as it is heated (bakes)—this is the next phase to curing the first protein because of the sodium content in the lactose-free dairy products there is no need to add any salt or sugar for curing. The lactose-fee dairy products can be sprinkled thinly and evenly on top of the mixed, spread first base composition, which keeps the lactose-free dairy products from burning while baking.

The first preparation method may include an additional step of heating the first base composition on said cooking apparatus at a first predetermined temperature for a first predetermined time, in one embodiment, baking in an oven at 375 degrees for 20 to 25 minutes, respectively.

Said process may include a second method of provide a second base composition, the second method possibly having the following steps:

The second method may include a step of adding a predetermined amount of second protein to a second container, in one embodiment two cups of pre-cooked shredded chicken along with one and a half to two cups of lowest sodium hot cayenne pepper sauce and two tsp of oregano.

The second method may include an additional step of adding a predetermined amount of a third seasoning to the second container, in one embodiment one tsp of dehydrated sofrito flavoring, two tsp ground black pepper, and one tsp of cumin powder.

The second method may include an additional step of adding a predetermined amount of an acidic fluid to the second container. The acidic fluid has an acidity range of approximately 2.00 to 2.35 pH. In one embodiment the acidic fluid is preferably one-half tablespoon (tbs) of lime juice. In another embodiment, the acidic fluid may be lemon juice, though that may be outside said acidity range. The acidic fluid has the unexpected result of prolonging the shelf life of the resulting food stuff. And so lends itself to the advantages of the present invention, even though current preparations of like food stuff teaches away from the addition of highly acidic fluid (2.00 to 2.35 pH).

The second method may include an additional step of mixing the second base composition in the second container until the second protein is saturated with the third seasoning and the acidic fluid.

A second preparation method may include an additional step of thinly spreading a second spread of the second base composition on said cooking apparatus. Said second spread may have a thickness of about ⅛ of an inch; in some embodiments, the thickness is between 1/16th and ¼th of an inch.

The second method may include an additional step of adding a predetermined amount of third lactose-free dairy on the thinly spread second base composition, in one embodiment three cups of shredded lactose free muenster cheese sprinkled with garlic powder, ground black pepper and grated parmesan.

The second method may include an additional step of adding a predetermined amount of fourth lactose-free dairy, in one embodiment three-quarters of an ounce of blue cheese crumbles and two tsp of grated parmesan cheese.

The second method may include an additional step of adding a predetermined amount of fifth lactose-free dairy on the thinly spread second base composition, in one embodiment a fourth of a cup of lactose-free zested cheddar cheese, lightly sprinkled.

The order of this assembly is crucial for infusion of the protein, spices and sauces into the lactose-free dairy products as well as keeping the individual lactose-free dairy products protected from burning while baking. Especially the blue and cheddar cheese, as they need to be protected in the cooking process. In other words, the placement of each component is done to prevent each item from burning, and the strategic location of each item aids in the infusion process needed to create a thick sheet of spicy cured meat jerky cheese bark. The specific herbs, spices and seasoning: oregano, ground cumin, black pepper, cayenne pepper sauce, and chipotle peppers are all proven to fight microbials and bacteria from forming, all contain anti-inflammatory properties and are natural antioxidants, while they are also a great compliment to the flavor of the jerky meat and cheese bark.

The second preparation method may include an additional step of heating the second base composition on said cooking apparatus at a second predetermined temperature for a second predetermined time, in one embodiment, baking in an oven at 375 degrees for 20 to 25 minutes, respectively.

Said process may include a third preparation method of preparing the first and/or second base compositions, post first and second preparation methods; the third preparation method possibly having the following steps:

The third preparation method may include a step of providing a drying apparatus, in one embodiment one 11×17 bakery drying rack.

The third preparation method may include an additional step of placing the first and/or second base compositions on the drying apparatus for a third predetermined time.

The third preparation method may include an additional step of placing a third protein on the first or second base composition, in one embodiment two tbs Turkey pepperoni and one sliced tomato, possibly Juliet Roma tomatoes.

Oregano, black pepper, cumin powder, cayenne pepper sauce, and chipotle peppers are all-natural antioxidants and possess antibacterial, antimicrobial and anti-fungal properties. All may be included in the above-mentioned process for the purpose of curing and keeping the proteins fit for consumption. All of the above systemic components may be found to be delicious and add to the flavorful sensory experience of the present invention of cheese bark as well as sustains the shelf life of the meats. The lactose-free dairy products (cheeses) makes them ideal for high temperature baking, which in turn facilitates a shorter time for drying and curing the encased protein, relative to the prior art. These cheeses also happen to be more digestible than regular cheeses containing lactose. The lactose-free cheeses muenster, cheddar, blue and parmesan cheeses all add to the flavor of the consumable and produce a highly digestible low carbohydrate provision.

The seasoned meat may be incorporated into the cheese by the assembly or order in which the process is laid out. The assembly keeps specific cheeses and areas of the pan from burning. For instance, one cannot put the meat on last because it will not be encased in the cheese therefore eliminating a step that facilitates keeping the meat cured. The cheese bark is a combination of lactose free cheeses specifically chosen because they bake better than regular cheeses and they are more digestible. These particular cheeses form a crispy crunchy glass like sheet of sodium and fat that encases the meats as it cooks to preserve the meats. The herbs and spices are also chosen specifically to utilize their flavors and preservation properties. The purpose of the specified cayenne and chipotle pepper sauces herb, spices and seasoning is for their intense flavors and preservation properties. As a result of the above-disclosed infusion by encasement (shortened) curing process and shortened drying by high-temperature baking (enabled by lactose-free dairy products) process with a specific ordered combination of steps, the present invention of jerky cheese bark is an ideal “low-carb” snack having a great flavor and a long shelf life. The inventor has created a new way of enjoying beef jerky and cheese tasting.

In one embodiment, the present invention may include shredding approximately three cups of lactose free muenster cheese, shred approximately ¼ cup lactose free cheddar cheese. As they are shredded, they should be sprinkled with black pepper and garlic powder and parmesan cheese to keep the shredded cheeses from caking and sticking together. This step also enhances flavor and adds to the preservation of the shelf life of the resulting consumable. Set aside each of these cheeses in separate bowls.

Next, place approximately two cups pre-cooked shredded chicken or beef or pork into a medium bowl. To the meat add two cups of lowest sodium cayenne hot pepper sauce, one tsp cumin powder, add two tsp of oregano add 1 tsp dehydrated sofrito spices and two tsp black pepper. Combine together to saturate the meat with the hot sauce herb and spices.

Then spread meat mixture thinly and evenly onto ungreased non-stick cookie sheet. Then sprinkle shredded muenster cheese on top of meat mixture thinly and evenly. Then on top of that sprinkle the shredded cheddar cheese. Then bake at 375 degrees for approximately 20 to 25 minutes or until edges are brown and crispy. Check frequently for doneness.

For buffalo chicken flavor, to the meat mixer you add one tablespoon of lime juice, and one tsp of parmesan cheese. You would add one ounce blue cheese or gorgonzola crumbles after laying meat mixture onto the cookie sheet, then cover the cheese crumbles with the muenster cheese then cheddar cheese in that order to keep the blue cheese crumbles from burning. The cheddar cheese should always be sprinkled on last so it doesn't burn or become bitter from being scorched.

For the Chipotle beef flavor one would add two stewed and ground chipotle peppers in adobo sauce to the meat mixture. Then spread the meat mixture thinly and evenly onto the ungreased nonstick cookie sheet. Then sprinkle the shredded muenster cheese thinly and evenly on top of the meat mixture then sprinkle the shredded cheddar on top of the muenster cheese. Place in 375-degree oven and bake for 20 to 25 minutes or until edges are brown and crispy, checking frequently for doneness. Remove from oven and immediately place onto dry rack by placing dry rack on top of baked cheese and flipping cheese over onto dry rack. Immediately after, flip cheese over the face or back in the upright position, before removing the resulting consumable from the cookie sheet. Let stand until completely cooled then place back in oven on lowest setting or warm for approximately 35-45 minutes to dry out the sheet of cheese bark, remove, and then let stand until completely cooled.

The present invention provides an alternative to using high-carbohydrate consumables, like breadcrumbs on a salad, or crackers in soup, or as a snack on a hike. Especially today, consumers who cannot chew hard beef jerky can now enjoy the easy to chew jerky of the present invention. Consumers who are lactose intolerant can enjoy a lactose free cheese snack.

It should be understood, of course, that the foregoing relates to exemplary embodiments of the invention and that modifications may be made without departing from the spirit and scope of the invention as set forth in the following claims.

What is claimed is:

1. A method for producing a consumable for low-carbohydrate snacking, comprising:
mixing a protein and one or more seasonings to form a first base composition;
providing a sheet having thermal conductive properties;
spreading the first base composition on said sheet;
sprinkling one or more first lactose-free dairy products over the first base composition; and
subjecting said sheet to a predetermine temperature for a predetermined length of time so as to infuse said one or more seasonings into said protein resulting in a low-carbohydrate snack,
whereby adding sugars and salts to cure the protein is eliminated and lessening a drying time for the low-carbohydrate snack.

2. The method of claim 1, wherein said protein comprises one protein selected from the group consisting of a portion of pre-cooked beef, a portion of pre-cooked chicken, and a portion of pre-cooked pork.

3. The method of claim 2, wherein the one or more seasonings comprises one or more herbs and spices selected from the group consisting of a chipotle pepper, a garlic powder, a cumin, a black pepper, a dehydrated sofrito, and a cayenne pepper.

4. The method of claim 3, wherein the one or more first lactose-free dairy products comprises one or more shredded cheeses selected from the group consisting of a muenster cheese, a parmesan cheese, and a cedar cheese.

5. The method of claim 4, further comprising mixing an acidic fluid to the first base composition prior to sprinkling the one or more lactose-free dairy products.

6. The method of claim 5, wherein the acidic fluid is lime juice.

7. The method of claim 3, wherein the one or more first lactose-free dairy products comprises shredded muenster cheese.

8. The method of claim 7, wherein the shredded muenster cheese is mixed with grated lactose-free parmesan cheese prior to sprinkling the one or more lactose-free dairy products.

9. The method of claim 8, further comprising sprinkling lactose-free cheddar over the one or more first lactose-free dairy products prior to subjecting said sheet to the predetermine temperature for the predetermined length.
